(19) United States
(12) Patent Application Publication
(10) Pub. No.: US 2023/0366102 A1
(43) Pub. Date: Nov. 16, 2023

(54) POLYACRYLAMIDES AS VOLATILE CORROSION INHIBITORS AND DESICCANTS, METHODS OF USING, AND METHODS OF MAKING THE SAME

(71) Applicant: Northern Technologies International Corporation, Circle Pines, MN (US)

(72) Inventors: Mahin Shahlari, North Oaks, MN (US); Mitchell Fillbach, St. Paul, MN (US)

(21) Appl. No.: 18/315,659

(22) Filed: May 11, 2023

Related U.S. Application Data
(60) Provisional application No. 63/364,583, filed on May 12, 2022.

(51) Int. Cl. C23F 11/14; C08L 33/26; B29C 48/08

(52) U.S. Cl. CPC C23F 11/145; C08L 33/26; B29C 48/08; B29K 2033/26

(57) ABSTRACT

A volatile corrosion inhibitor composition comprising about 1 wt. % to about 100 wt. % of a polyacrylamide is disclosed that prevents corrosion of metal materials. A volatile corrosion inhibitor composition may also include a second volatile corrosion inhibitor selected from the group consisting of: ammonium salt, triazole, nitrite, nitrate, an amine carboxylate, an amine, a carboxylic acid, aldehyde, anhydride and any combination thereof. An anticorrosion method of a metal material using the volatile corrosion inhibitor composition is also disclosed.

### CROSS-REFERENCE TO RELATED APPLICATION

This application claims the benefit of priority to U.S. Provisional Patent Application No. 63/364,583 filed May 12, 2022, the entire contents of which are incorporated by reference herein.

### FIELD OF THE DISCLOSURE

The disclosure relates to a volatile corrosion inhibitor composition comprising a polyacrylamide for preventing corrosion of metal materials. The volatile corrosion inhibitor composition exhibits excellent anticorrosive effects on both ferrous alloys and non-ferrous alloys typically used in industry such as aluminum, copper, zinc, nickel, tin, silver and their alloys.

### BACKGROUND OF THE DISCLOSURE

The corrosion of metal components and parts used in a variety of industries during transport, storage and usage can be a significant problem. Thus, temporary protection of these metals against corrosion is an important step in the production and assembly of these metal materials. One way to afford this protection is through treating the environment surrounding the metal material rather than directly treating the metal itself, which is significantly more labor intensive to apply and remove. The two most critical factors in the environment that contribute to corrosion are humidity and contamination. A desiccant can reduce the relative humidity inside a package or other closed environment. A volatile corrosion inhibitor (VCI) can protect a metal surface by volatilizing a chemical in the environment and depositing on the metal surface in such a way as to keep moisture from corroding the metal surface by protecting the metal's natural oxide layer, creating a molecular level barrier on the metal surface and shielding the metal surface from contaminants in the environments or on the surface that promote corrosion. VCI materials are widely used to provide temporary corrosion protection for the surfaces of metal materials.

There are variety of known desiccant products, including clay, silica gel, molecular sieves, calcium chloride, and magnesium chloride, and also known VCI products in the market, including ammonium salts, nitrite salts, amines, amine salts, aldehydes, anhydrides, carboxylic acids, and carboxylic acid salts. There are also a number of products marketed as VCI-desiccants used in form of an emitter, diffuser, or otherwise coated onto, or incorporated into a substrate. These products combine one or more of the above desiccants with one or more of the above VCIs.

### SUMMARY OF THE DISCLOSURE

A volatile corrosion inhibitor composition containing cross-linked, non-cross-linked (i.e., linear chain), or a combination of linear and cross-linked polyacrylamides (PAM) is disclosed. The volatile corrosion inhibitor composition may function as both a volatile corrosion inhibitor (VCI) and a desiccant. The volatile corrosion inhibitor composition may include about 1 wt % to about 100 wt. % of a polyacrylamide, which may optionally be cross-linked, or a linear chain. The volatile corrosion inhibitor composition may include up to about 99 wt. %, or up to about 90 wt. %, of a second volatile corrosion inhibitor. The second volatile corrosion inhibitor may be selected from the group consisting of: ammonium salt (e.g., ammonium benzoate), a triazole (e.g., benzotriazole), nitrite (e.g., nitrite salts, such as sodium nitrite), nitrate (e.g., nitrate salts, such as sodium nitrate), an amine carboxylate, an amine, a carboxylic acid, aldehyde, anhydride, and any combination thereof. The volatile corrosion inhibitor composition may be packaged in polymeric, natural fiber, or nonwoven material, paper, or in any flexible or rigid, breathable container, or otherwise, used in bulk form.

Methods of using polyacrylamides are disclosed for preventing corrosion of metal. A method of making the volatile corrosion inhibitor comprising PAM is also disclosed. An anticorrosion method of a metal material is disclosed including the steps of: providing a metal material, optionally, in a closed environment; and providing a volatile corrosion inhibitor composition, wherein the volatile corrosion inhibitor composition prevents corrosion of the metal material. When present, the closed environment may be a pouch or sachet made from any breathable material placed within a polymeric film, a control cabinet, or inside a container or equipment with limited gas transmission. The volatile corrosion inhibitor composition may otherwise be coated onto a paper, foam or any porous substrate. The volatile corrosion inhibitor composition may be extruded into a monolayer or multi-layer polymer film or any profile, or injection molded into a part or can be added to a liquid to form a gel/semi solid medium.

### BRIEF DESCRIPTION OF THE FIGURE

FIG. 1 are photographs of steel panels after 24 hours exposure showing the differing anticorrosive effect of certain compositions.

FIG. 2 is a graph showing the relative humidity (RH) inside packages with different desiccants over the first 10 days of the test where the chamber was set at 40° C. and 95% RH.

FIG. 3 is a graph showing the RH inside packages with different desiccants over days 11 and 12 where the chamber was set at 50° C. and 93% RH.

### DETAILED DESCRIPTION OF THE DISCLOSURE

The disclosure relates to a volatile corrosion inhibitor composition comprising a polyacrylamide (PAM) that has excellent anticorrosive effects on both iron and certain nonferrous metals, such as aluminum. The volatile corrosion inhibitor comprising PAM is used for preventing corrosion of metal materials, and may also function as a desiccant to remove moisture from the environment and provide protection for other types of metals through reducing the relative humidity level as well. The anticorrosive effect may be achieved without direct contact between the metal and PAM. Polyacrylamide's VCI generation may be on-demand, or alternatively referred to as “smart,” meaning polyacrylamide is responsive to the environment and generates more VCI and adsorbs more moisture when the temperature and humidity of the environment is increased and the chance of corrosion is higher.

PAM is a polymer having the following formula:

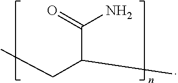

The polymer can be synthesized as a simple linear chain or as a cross-linked structure. The cross-linked polymer can adsorb and retain large amounts of water because the amide groups form strong hydrogen bonds with water molecules. The weight average molecular weight Mw of the polyacrylamides used in accordance with this disclosure is from about 1.0×10⁶ g/mol to about 50×10⁶ g/mol, from about 1.5×10⁶ g/mol to about 30×10⁶ g/mol, from about 2.0×10⁶ g/mol to about 25×10⁶ g/mol, from about 1.0×10⁶ g/mol to about 1.0×107 g/mol, or from about 8.0×10⁶ g/mol to about 18×10⁶ g/mol. The PAM may be polyacrylamide homopolymer, copolymers containing acrylamide, or a combination thereof. Acrylamide containing copolymers, such as acrylamide and acrylic acid co-polymer, show similar results due to the presence of a structure similar to the PAM formula.

The volatile corrosion inhibitor composition may include about 1 wt. % to about 100 wt. %, about 10 wt. % to about 90 wt. %, about 10 wt. % to about 50 wt. %, about 10 wt. % to about 20 wt. %, about 20 wt. % to about 90 wt. %, about 20 wt. % to about 80 wt. %, about 30 wt. % to about 80 wt. %, about 40 wt. % to about 95 wt. %, about 40 wt. % to about 100 wt. %, about 50 wt. % to about 100 wt. %, about 60 wt. % to about 100 wt. %, about 80 wt. % to about 100 wt. %, about 80 wt. % to about 90 wt. %, about 90 wt. % to about 100 wt. %, or about 100 wt. % of a polyacrylamide. The volatile corrosion inhibitor composition may include about 10 wt. %, about 20 wt. %, about 50 wt. %, or about 90 wt. % of a polyacrylamide. The polyacrylamide may be a linear chain. The polyacrylamide may be a cross-linked polyacrylamide, and may be a PAM homopolymer, co-polymer, or combination thereof.

Without being limited to one theory, it is believed that PAM acts as a VCI by degradation and/or hydrolysis, thereby emitting ammonia and/or other compounds that inhibit corrosion of the metal material. The rate of hydrolysis is dependent on temperature and humidity of the environment, therefore, higher temperatures and humidity, results in a higher amount of VCI being generated. More specifically, for example, PAM works as a VCI by emitting a vapor such as an amine-based compound. PAM may react with water to release an amino group (—NH₂) from the polymer chain, which forms ammonium ion. The nitrogen on the amino group may be attracted to the polar metal surface, and once this attraction transpires, the rest of the molecule repels water from the metal surface to reduce corrosion. This also generates OH— groups that helps with preservation of oxide layers on metal surfaces (see U.S. Pat. No. 7,824,482 B2).

Higher temperature and humidity accelerate corrosion of metals. When the volatile corrosion inhibitor composition disclosed herein is placed into a closed container with a metal material and a contaminant, VCI generation is “on-demand” meaning PAM is responsive to the environment and more VCI is generated when the temperature and humidity of the environment is increased. As such, the volatile corrosion inhibitor composition disclosed herein may be referred to as a responsive, or smart, VCI.

Any chemical that would increase the rate of hydrolysis of PAM may increase the amount of VCI generated and therefore improve its volatile corrosion inhibition (VCI) performance. For example, addition of a non-volatile base (with pH of above about 8.0) may increase the amount of ammonia that is emitted by the polyacrylamide, thereby improving its capability as a VCI.

The anticorrosive effect of PAM may be increased by the addition of a second volatile corrosion inhibitor to the volatile corrosion inhibitor composition. The second volatile corrosion inhibitor may be any known volatile corrosion inhibitor for use in the art. The second volatile corrosion inhibitor may be a carboxylic acid, carboxylic acid salt, ammonium salt, nitrite, amine, amine salt, aldehyde, anhydride, triazole, or any combination thereof. The second volatile corrosion inhibitor may be selected from: ammonium benzoate, benzotriazole, sodium nitrite, nitrate, an amine carboxylate, an amine, and any combination thereof. When present, the volatile corrosion inhibitor composition may contain up to about 90 wt. % of the second volatile corrosion inhibitor. The volatile corrosion inhibitor composition may contain about 0.01 wt. % to about 90 wt. %, about 0.1 wt. % to about 90 wt. %, about 0.1 wt. % to about 50 wt. %, about 0.1 wt. % to about 30 wt. %, about 0.1 wt. % to about 10 wt. %, about 1 wt. % to about 10 wt. %, about 1 wt. % to about 30 wt. %, about 1 wt. % to about 20 wt. %, or about 5 wt. % to about 10 wt. % of the second volatile corrosion inhibitor.

The volatile corrosion inhibitor composition may include one or more additives. The additive may be selected from silicates, carbonates, or oxides of alkaline and alkaline metals or minerals, such as sand, talc, mica, vermiculite or organic fillers, such as starch, cellulose based material or resins such as polyethylene. When present, the volatile corrosion inhibitor composition may contain up to about 50 wt. % of the additive. The volatile corrosion inhibitor composition may contain about 0.01 wt. % to about 50 wt. %, about 0.1 wt. % to about 40 wt. %, about 0.1 wt. % to about 30 wt. %, about 0.1 wt. % to about 10 wt. %, about 0.1 wt. % to about 5 wt. %, about 1 wt. % to about 20 wt. %, about 1 wt. % to about 10 wt. %, or about 1 wt. % to about 5 wt. % of the additive.

The volatile corrosion inhibitor composition may contain about 60 wt. % to about 90 wt. %, or about 80 wt. % to about 90 wt. % of a polyacrylamide, and about 1 wt. % to about 40 wt. %, or about 1 wt. % to about 10 wt. % of one or more second volatile corrosion inhibitors. The volatile corrosion inhibitor composition may contain about 90 wt. % of a polyacrylamide and about 1 wt. % to about 4 wt. % of one or more second volatile corrosion inhibitors. The volatile corrosion inhibitor composition may contain about 1 wt. % to about 30 wt. %, or about 10 wt. % to about 20 wt. % of a polyacrylamide, and about 60 wt. % to about 95 wt. %, or about 70 wt. % to about 90 wt. % of one or more second volatile corrosion inhibitors. The volatile corrosion inhibitor composition may contain about 50 wt. % to about 95 wt. % of a polyacrylamide, about 1 wt. % to about 20 wt. % of a second volatile corrosion inhibitor, and about 0.1 wt. % to about 20 wt. % of one or more additives. The volatile corrosion inhibitor composition may contain about 1 wt. % to about 50 wt. % of a polyacrylamide, about 1 wt. % to about 70 wt. % of a second volatile corrosion inhibitor, and about 1 wt. % to about 20 wt. % of one or more additives.

In an embodiment, when a second volatile corrosion inhibitor is added to the volatile corrosion inhibitor composition, the PAM functions both as a desiccant and a volatile corrosion inhibitor, the second volatile corrosion inhibitor functions as an additional VCI. As a desiccant, the PAM adsorbs humidity from the air and creates and sustains a lower humidity environment compared to a system that does not have any desiccant.

For the inventive volatile corrosion inhibitor composition containing PAM and a second volatile corrosion inhibitor, the efficacy of the volatile corrosion inhibitor composition is not substantially reduced. Substantial reduction of efficacy as used herein means that the efficacy is reduced more than about 10% with the addition of a second VCI. This was surprising because the combination of traditional desiccants, e.g., clay and silica gel, with known volatile corrosion inhibitors, results in reduced VCI and desiccation ability, because the desiccant adsorbs some of the VCI, thereby reducing the efficacy of the VCI, while reducing the efficacy of the desiccant which then has less capacity for adsorbing water. It was found that this is not the case for the combination of the inventive volatile corrosion inhibitor composition including PAM and a second volatile corrosion inhibitor.

The volatile corrosion inhibitor composition may be packaged in high-density spunbound polyethylene fibers (e.g., Tyvek®), nonwoven material, or polymer films, such as nylon, polyethylene, polyethylene terephthalate, or paper. Any known container used in the art with desiccants may be used to package the volatile corrosion inhibitor composition. It also may be packaged in any rigid container that allows gas and water vapor transmission. It may be sold and used in bulk form. The volatile corrosion inhibitor composition may be compounded, injection molded, extruded into a film or added to a liquid to form a gelled/semi-solid medium.

The metal materials include ferrous metal materials and nonferrous metal materials, such as those made of copper and brass. In addition, use in combination with an anticorrosive component for nonferrous metal materials such as copper and brass allows demonstration of multiplicatively excellent anticorrosive ability not only to nonferrous metal materials but to iron based metal materials.

The volatile corrosion inhibitor composition may include a chemical having a high pH which functions as a deliquescing material that is capable of increasing the water adsorption of the package. The deliquescing material added to the volatile corrosion inhibitor composition may be, but is not limited to, calcium chloride, magnesium chloride, urea, sodium nitrate. The volatile corrosion inhibitor composition may include an imidazole and/or triazole/azole compound to provide further yellow metal protection. The volatile corrosion inhibitor composition may include about 1 wt. % to about 50 wt. %, about 5 wt. % to about 50 wt. %, or about 10 wt. % to about 30 wt. % of a deliquescing material. The volatile corrosion inhibitor composition may include the deliquescing material calcium chloride. When present, the volatile corrosion inhibitor composition may contain about 40 wt. % to about 80 wt. %, or about 50 wt. % of a polyacrylamide and about 5 wt. % to about 50 wt. % of a deliquescing material, and optionally one or more second volatile corrosion inhibitors at 1 to 40%. The volatile corrosion inhibitor composition may contain about 40 wt. % to about 80 wt. % of a polyacrylamide, about 10 wt. % to about 30 wt. % of one or more second volatile corrosion inhibitors and about 10 wt. % to about 30 wt. % of a deliquescing material.

An anticorrosion method of a metal material is disclosed. A method for protecting metal placed in a corrosive environment is also disclosed. The method includes supplying the volatile corrosion inhibitor composition disclosed herein into the corrosive environment with the metal. The PAM may act as a VCI by preventing or reducing corrosion of the metal, and optionally also as a desiccant by removing moisture from the environment.

The duration of the anticorrosive effects of the composition is highly dependent on humidity and temperature of the environment. It may also depend on how sealed the environment is. If the composition is sealed with metal parts in an aluminum foil bag, it may continue to provide anticorrosion protection for several years, e.g., about 2 years. If the composition is sealed with metal parts in a polyethylene bag, it too may be dependent on the humidity and temperature as the water vapor transmission rate of the packaging material would be significantly different at different levels of temperature and humidity. The temperature and humidity also affect how much VCI is given off by PAM as well. The metal surface area also may make a difference in the longevity. Cast iron and sintered metal, which have more surface area, or heavily contaminated metal surfaces may reduce the duration of the anticorrosive effects of the composition, e.g., to about 6 months to about 24 months, or about 6 months to about 12 months.

When sold in emitter packet form, the volatile corrosion inhibitor composition may be fed through packaging equipment capable of feeding a specific amount of the volatile corrosion inhibitor composition into a plurality of packets made from a heat sealable material. It can also be fed into any rigid container that allows water vapor transmission. If used in bulk, the volatile corrosion inhibitor composition may be placed in a container (aluminum foil bag or pail or drum) and sealed and delivered to the enclosure such as inside a metallic enclosure.

An amount of the volatile corrosion inhibitor composition may be enclosed within any container known for use with traditional desiccants, such as a pouch or sachet, or within a polymer film, or is coated onto a paper, foam or a porous substrate. The sachet or the pouch may be made of any breathable material, meaning that air passes easily through the material. An amount of the volatile corrosion inhibitor composition may be extruded into a monolayer or multi-layer polymer film, injection molded into a part, or added to a liquid to form a gel or semi-solid medium. The amount (in weight) of the volatile corrosion inhibitor composition can be any amount known for use with traditional desiccants made and sold in the market. For example, the amount may be about 1 gram to about 1500 grams, about 1 gram to about 700 grams, about 1 gram to about 500 grams, about 1 gram to about 100 grams, or about 1 gram to about 50 grams. The size of the container depends on the volume of the space that needs anticorrosion protection. The pouch or sachet may then be placed within an environment, optionally an enclosed environment, in the presence of the metal material. A closed environment may be polymeric film, a control cabinet, inside an equipment or inside any container with limited gas transmission.

The volatile corrosion inhibitor composition may work by volatizing and emitting amines and ammonia, or otherwise providing anticorrosion effects, and optionally by removing moisture from the environment. The volatile corrosion inhibitor composition may have anticorrosive effects for at least about 6 months, at least about 12 months, more than about 2 years, or more than about 3 years. The volatile corrosion inhibitor composition may have anticorrosive effects for about 6 months to about 3 years.

### EXAMPLES

### Example 1

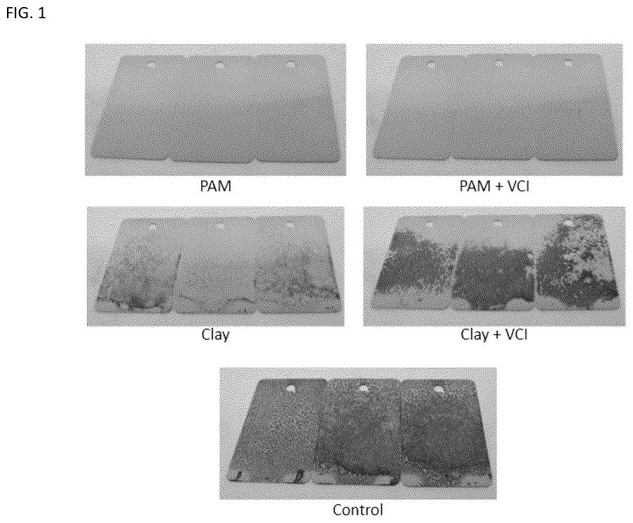

A test was performed to study anticorrosive effect on steel panels. Cold rolled steel panels were brought to 90° C. in an oven before being spritzed with 70 ppm in methanol solution. The panels were then placed into rectangular plastic holders and 3 of these holders were placed into a 9×12 2 mil polyethylene bags. Nonwoven high-density polyethylene (similar to Tyvek®) sachets were prepared containing one of: i) 8 grams of 100% PAM, ii) 8 grams of PAM+VCI (in a mixture of 90 wt. % PAM and 10 wt. % ammonium benzoate), iii) 16 grams of clay, or iv) 16 grams of clay and ammonium benzoate in a weight ratio of 9 to 1 (90 wt. % clay, and 10 wt. % ammonium benzoate). A control, i.e., a filled polyethylene bag with no pouch, was also prepared. The packages were then placed into a chamber running IEC60068-2-30 cycle: 6-hour dwell @ 25° C. and ˜98% relative humidity, 3-hour ramp to 55° C. and ˜95% relative humidity, 9-hour dwell @ 55° C. and ˜93% relative humidity, and 6-hour ramp to 25° C. and ˜98% relative humidity. FIG. 1 shows the panels upon inspection after the 24 hours. Table 1 shows the percentage of corrosion observed on the panels upon inspection after the 24 hours.

TABLE 1

| | Corrosion level |
|---|---|
| | (average of three panels) |
| PAM | <5% |
| PAM + VCI | <5% |
| Clay | 30-40% |
| Clay + VCI | 60-70% |
| No Emitter | 100% |

The control panels (without PAM, VCI or desiccant) showed the highest level of corrosion. The panels stored in the presence of clay (a known, traditional desiccant) with VCI (ammonium benzoate) showed more corrosion than the panels stored in the presence of clay alone. This is most likely due to adsorption of the VCI by the desiccant, thereby reducing the efficacy of both of the VCI and the desiccant.

PAM alone, and PAM+VCI (ammonium benzoate) showed anticorrosive effects and protected the panels from corrosion. PAM+VCI (ammonium benzoate) provided the best protection.

### Example 2

The desiccation effect of PAM was demonstrated by measuring the weight gain of a material showing adsorption of water. The weight gain study was conducted according to Mil-D-3464E test method with 10 gram samples. The weight of the samples was measured at 24 hour intervals. After a steady state was reached, the humidity and temperature were adjusted to the next level. The percentage weight gains at each temperature and humidity setting for PAM, PAM+VCI (10% ammonium benzoate), Clay, and Clay+VCI (10 wt. % ammonium benzoate) samples are reported in the table below. The weight gain was not as significantly affected by mixing VCI with PAM as when the same VCI mixture was added to clay.

TABLE 2
Weight increase percentage of samples at different temperatures and relative humidity

| | 40% RH/ | 60% RH/ | 80% RH/ | 80% RH/ | 90% RH/ | 98% RH/ |
|---|---|---|---|---|---|---|
| | 25° C. | 25° C. | 25° C. | 45° C. | 45° C. | 45° C. |
| PAM/VCI | 16.35% | 23.56% | 38.90% | 44.04% | 82.89% | 102.86% |
| PAM | 15.97% | 24.94% | 40.68% | 46.30% | 83.15% | 98.56% |
| Clay/VCI | 20.73% | 22.65% | 26.87% | 27.95% | 30.83% | 31.61% |
| Clay | 26.22% | 28.34% | 31.15% | 31.76% | 35.94% | 37.53% |

The delta values between the weight gain of PAM and PAM/VCI samples and the delta between clay and clay/VCI samples were calculated from the data in Table 2 and are reported in Table 3, which shows a greater change in the desiccation ability of clay in presence of VCI compared to PAM in presence of VCI.

TABLE 3
Difference of the temperature and humidity settings

| | 40% RH/ | 60% RH/ | 80% RH/ | 80% RH/ | 90% RH/ | 98% RH/ |
|---|---|---|---|---|---|---|
| | 25° C. | 25° C. | 25° C. | 45° C. | 45° C. | 45° C. |
| PAM/VCI vs. PAM | 2.33% | −5.53% | −4.36% | −4.87% | −0.30% | 4.37% |
| Clay/VCI vs. Clay | −20.96% | −20.10% | −13.74% | −11.99% | −14.23% | −15.77% |

### Example 3

Five 0.1 cubic meter frames were constructed from aluminum extrusion rods. Each frame was placed inside of a shape fitting polyethylene 4 mil bag and before closing the bag, three chloride contaminated panels (prepared similar to Example 2) were hung in the middle of each frame.

One 100 gram pack of either: i) PAM, ii) Calcium Chloride Super absorbent polymer desiccant (“CaCl desiccant”), iii) clay, or iv) silica gel was placed on the bottom of each shaped and filled polyethylene bag. One shaped and filled polyethylene bag was set up without any VCI or desiccant as a control. The shaped and filled polyethylene bags were sealed and then placed inside a large environmental chamber set at 40° C. and 95% RH for 10 days and subsequently at 50° C. and 93% RH for 2 days.

Table 4 presents the percentage of corrosion seen on average on three panels after completion of this test. The results show the level of corrosion inhibition in the following order: PAM>CaCl desiccant>Silica gel, clay, and control.

TABLE 4

| | Corrosion level |
|---|---|
| | (average of three panels) |
| PAM | <5% |
| CaCl & super absorbent polymer | 50-60% |
| Silica gel | 100% |
| Clay | 100% |
| Control | 100% |

The packs were weighed before and after the test and the weight gain percentage of the packs at the end of the test are shown in Table 5. The weight gain percentage shows the following order: CaCl desiccant>Silica gel>PAM>clay. Even though PAM showed less of a weight gain than Silica gel and CaCl desiccant as far as water adsorption, PAM outperformed Silica gel and CaCl desiccant in corrosion inhibition.

TABLE 5

| | % Weight Gain |
|---|---|
| PAM | 33% |
| CaCl desiccant | 61% |
| Silica Gel | 36% |
| Clay | 25% |

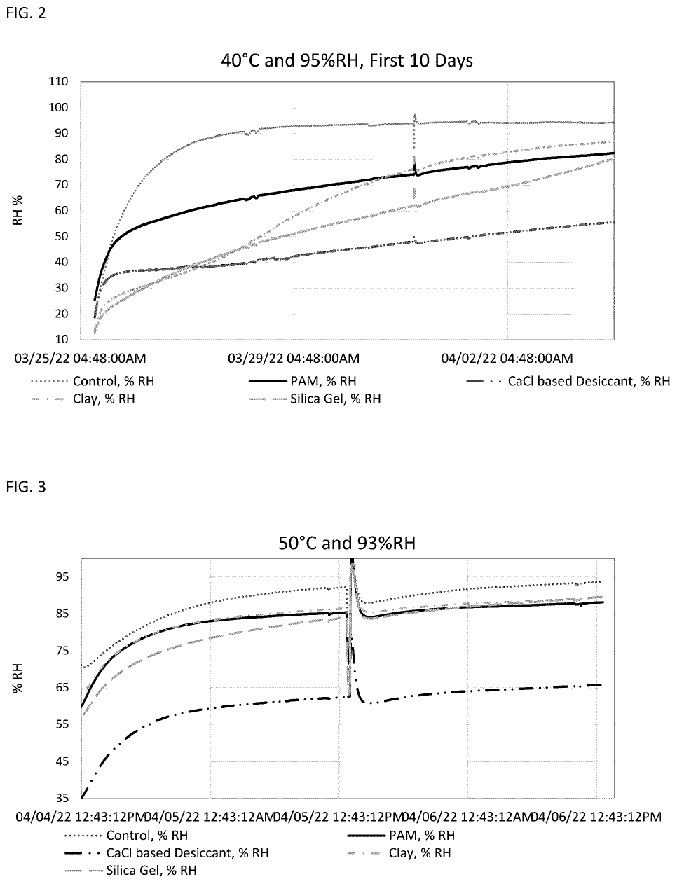

The humidity of each package was measured and logged using Onset MX2301A model data logger. The results for the first 10 days of the test where the chamber was set at 40° C. and 95% RH are shown in FIG. 2. The results for the last two days where the chamber was set at 50° C. and 93% RH are shown in FIG. 3. The relative humidity (RH) inside these packages with different desiccants shows that the PAM starts out slower than the other desiccants in controlling the humidity but as the test progresses, the RH of clay and silica gel package surpasses the RH of PAM containing package.

The corrosion inhibition, humidity evaluation and weight gain evaluation confirm that PAM acts as both a VCI and a desiccant.

### Example 4

Three 0.1 cubic meter frames were constructed from aluminum extrusion rods and each frame was placed inside of a shape fitting 4 mil polyethylene (PE) bag. Three 1010 steel panels (from Q panel Corporation, R35 type) were hung inside of each packed PE bag. A pouch made from high-density polyethylene (similar to Tyvek®) containing 50 gram of high-capacity desiccant (containing magnesium chloride and sodium polyacrylate) was placed inside one filled PE bag. A sachet containing 90% PAM, 7% ammonium benzoate and 2.5% Benzotriazole was placed inside the second filled PE bag. No VCI or desiccant was placed within the third filled PE bag; it only contained metal panels. The three PE bags were sealed, thereby creating a closed environment, and placed inside a walking chamber maintained at 100° F. (38° C.) and 98% RH for 27 days. The control showed corrosion on the first day and was fully corroded after 2 days. The first sign of corrosion occurred on the panels within the first bag packaged with MgCl based desiccant after 10 days and in 20 days these panels were severely corroded. The metal panels inside the second bag with PAM did not show any corrosion throughout the 27 day period of the test.

TABLE 6

| | First signs of | Days to severe |
|---|---|---|
| | corrosion | corrosion |
| PAM blend | None | No visible corrosion |
| MgCl Desiccant | 10 | 20 |
| Control (no VCI or desiccant) | 1 | 2 |

### Example 5

Immersion Silver panel (a thin layer (5-15 μin) of silver deposited on a copper surface of a PCB board), a brass part and electronic parts containing copper and brass were hung inside two 9×12 inch bags. A high-density polyethylene (similar to Tyvek®) sachet containing 90% PAM, 7% ammonium benzoate and 2.5% Benzotriazole was placed inside one of the bags. The sachet was sealed into the top of the bag so as to not to come into contact with the metal parts. The second bag did not contain any VCI or desiccant. These filled bags were sealed and placed inside a chamber connected to SO₂ gas and were exposed to the following cycles: 8 hrs with 0.1 L (˜300 ppm) of SO₂ at 30° C.; 8 hrs with 0.1 L SO₂ at 30° C.; 8 hrs with 0.2 L SO₂ at 38° C.; 8 hrs with 0.2 L SO₂ at 40° C.; and 8 hrs with 0.4 L SO₂ at 45° C. After the 5th cycle, the brass, copper and silver parts in the bag without any desiccant or VCI showed significant corrosion while no corrosion was visible on the parts that were in the bag with the PAM containing blend.

While there have been described what are presently believed to be various aspects and certain desirable embodiments of the disclosure, those skilled in the art will recognize that changes and modifications may be made thereto without departing from the spirit of the disclosure, and it is intended to include all such changes and modifications as fall within the true scope of the disclosure.

What is claimed:

1. A volatile corrosion inhibitor composition comprising about 1 wt. % to about 100 wt. % of a polyacrylamide.

2. The volatile corrosion inhibitor composition of claim 1, comprising about 10 wt. % to about 100 wt. % of a polyacrylamide.

3. The volatile corrosion inhibitor composition of claim 1, wherein the polyacrylamide is cross-linked.

4. The volatile corrosion inhibitor composition of claim 1, wherein the polyacrylamide is a linear chain.

5. The volatile corrosion inhibitor composition of claim 1, wherein the polyacrylamide is a homopolymer, a copolymer containing acrylamide, or a combination thereof.

6. The volatile corrosion inhibitor composition of claim 1, further comprising up to about 99 wt. % of one or more second volatile corrosion inhibitors.

7. The volatile corrosion inhibitor composition of claim 6, comprising up to about 90 wt. % of the one or more second volatile corrosion inhibitors.

8. The volatile corrosion inhibitor composition of claim 6, wherein the one or more second volatile corrosion inhibitors is selected from the group consisting of: ammonium salt, triazole, nitrite, nitrate, an amine carboxylate, an amine, a carboxylic acid, aldehyde, anhydride, and any combination thereof.

9. The volatile corrosion inhibitor composition of claim 6, comprising about 80 wt. % to about 90 wt. % of the polyacrylamide, and about 1 wt. % to about 10 wt. % of the one or more second volatile corrosion inhibitors.

10. The volatile corrosion inhibitor composition of claim 6, comprising about 10 wt. % to about 20 wt. % of the polyacrylamide, and about 70 wt. % to about 90 wt. % of the one or more second volatile corrosion inhibitors

11. The volatile corrosion inhibitor composition of claim 1, wherein the polyacrylamide is a volatile corrosion inhibitor and a desiccant.

12. The volatile corrosion inhibitor composition of claim 1, wherein the composition further comprises a deliquescing material.

13. The volatile corrosion inhibitor composition of claim 12, wherein the deliquescing material is present in about 1 wt. % to about 50 wt. % of the volatile corrosion inhibitor composition.

14. The volatile corrosion inhibitor composition of claim 1, wherein the composition is packaged in high-density polyethylene fiber, nonwoven material, paper, or polymer film.

15. An anticorrosion method of a metal material comprising:
providing a metal material in a closed environment;
providing the volatile corrosion inhibitor composition of any of the preceding claims into the closed environment;
wherein the volatile corrosion inhibitor composition prevents corrosion of the metal material.

16. The method of claim 15, wherein the volatile corrosion inhibitor composition is enclosed within a pouch or sachet, within a polymer film, or is coated onto a paper, foam or a porous substrate.

17. The method of claim 15, wherein the volatile corrosion inhibitor composition is extruded into a monolayer or multi-layer polymer film, injection molded into a part, or added to a liquid to form a gel or semi-solid medium.

18. The method of claim 15, wherein the PAM in the volatile corrosion inhibitor composition adsorbs humidity from the air and sustains a lower humidity environment compared to a system that does not have any desiccant.
